(19) United States
(12) Patent Application Publication
(10) Pub. No.: US 2009/0155033 A1
(43) Pub. Date: Jun. 18, 2009

(54) MULTI-PURPOSE TRANSPORT VEHICLE

(76) Inventors: Steve Olsen, Brainerd, MN (US); David Johnson, Saint Cloud, MN (US)

Correspondence Address: SCHWEGMAN, LUNDBERG & WOESSNER, P.A., P.O. BOX 2938, MINNEAPOLIS, MN, 55402, US

(21) Appl. No.: 12/207,619

(22) Filed: Sep. 10, 2008

Related U.S. Application Data
(60) Provisional application No. 60/971,013, filed on Sep. 10, 2007.

(51) Int. Cl. B60P 9/00

(52) U.S. Cl. 414/462

(57) ABSTRACT

A transport vehicle includes a power unit, an attachment accessory, and an attachment mechanism configured to removably attach the attachment accessory to the power unit.

### CROSS-REFERENCE TO RELATED APPLICATIONS

This application claims the benefit under 35 U.S.C. 119(e) of U.S. Provisional Application No. 60/971,013, filed on Sep. 10, 2007, which is hereby incorporated by reference in its entirety.

### FIELD OF THE INVENTION

The invention relates generally to motorized vehicles. More particularly, the invention relates to a transport vehicle.

### BACKGROUND

There are a variety of applications where a person needs to perform a task at an elevated height. When performing these tasks, it may be necessary for the person to move to different locations. While it is possible to use a ladder for performing these tasks, the person's productivity can be significantly reduced by repeatedly going up and down the ladder.

There are many other applications where it is desirable for a person to have mechanical assistance when moving materials or equipment. For example, moving large amounts of materials over extended periods of time can not only cause the person replacing the wheel barrow with a machine that will carry loads of 300 pounds or more over rough or smooth ground, or through narrow doorways thus saving time, and also the possibility of back or leg injury moving the same materials by hand.

### SUMMARY

One embodiment includes a transport vehicle including a power unit, an attachment accessory, and an attachment mechanism configured to removably attach the attachment accessory to the power unit.

Some embodiments are directed to a multi-purpose transport vehicle that generally includes a power unit and an attachment accessory. The power unit includes a frame, at least one motor, at least one power source and a controller.

The attachment accessory may have a variety of configurations depending on the intended use of the multi-purpose transport vehicle. In one configuration, the attachment accessory includes a platform and an enclosure for supporting a person at an elevated height. In still another configuration, the attachment accessory includes a dump box that is pivotally mounted to the power unit.

### BRIEF DESCRIPTION OF THE DRAWINGS

FIG. 1 is a side view of a multi-purpose transport vehicle according to one embodiment with a work platform attached thereto.

FIG. 2 is a front view of the multi-purpose transport vehicle.

FIG. 3 is a back view of the multi-purpose transport vehicle.

FIG. 4 is a top view of a power unit for a multi-purpose transport vehicle according to one embodiment.

FIG. 5 is a top view of a frame for the power unit.

FIG. 6 is a side view of a bearing assembly for use in the power unit.

FIG. 7 is a top view of an alternative accessory attachment mechanism.

FIG. 8 is a close-up view of the alternative accessory attachment mechanism of FIG. 7.

FIG. 9 is a first side view of a controller adapter for a controller of the multi-purpose transport vehicle.

FIG. 10 is a second side view of the controller adapter.

FIG. 11 is a bottom view of the controller adapter.

FIG. 12 is a perspective view of the multi-purpose transport vehicle with an extension from the work platform.

FIG. 13 is a perspective view of the multi-purpose transport vehicle with a scaffold adapter attached thereto.

FIG. 14 is a side view of the multi-purpose transport vehicle with a dump box attached thereto where the dump box is in a storage configuration.

FIG. 15 is a front view of the multi-purpose transport vehicle with the dump box in the storage configuration.

FIG. 16 is a side view of the multi-purpose transport vehicle with the dump box in a dumping configuration.

### DETAILED DESCRIPTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that the embodiments may be combined or that other embodiments may be utilized and that structural changes may be made without departing from the spirit and scope of the present invention. The following detailed description is, therefore, not to be taken in a limiting sense, and the scope of the present invention is defined by the appended claims and their equivalents.

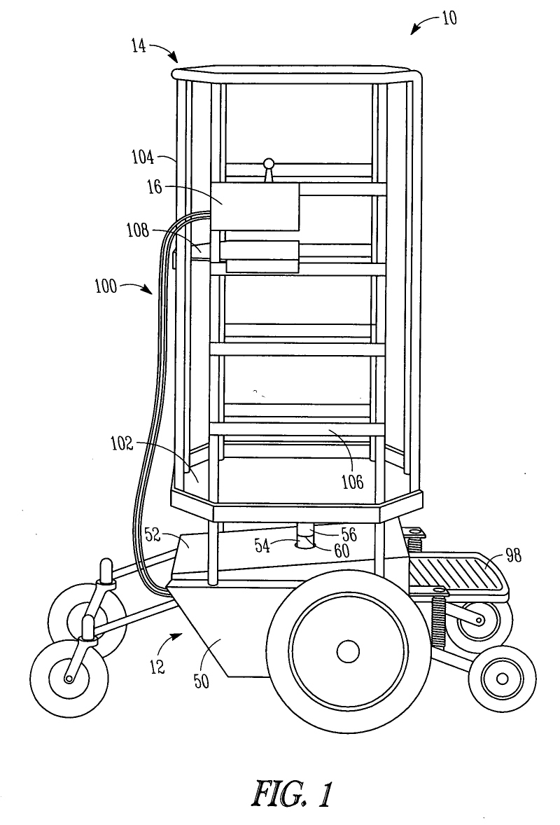

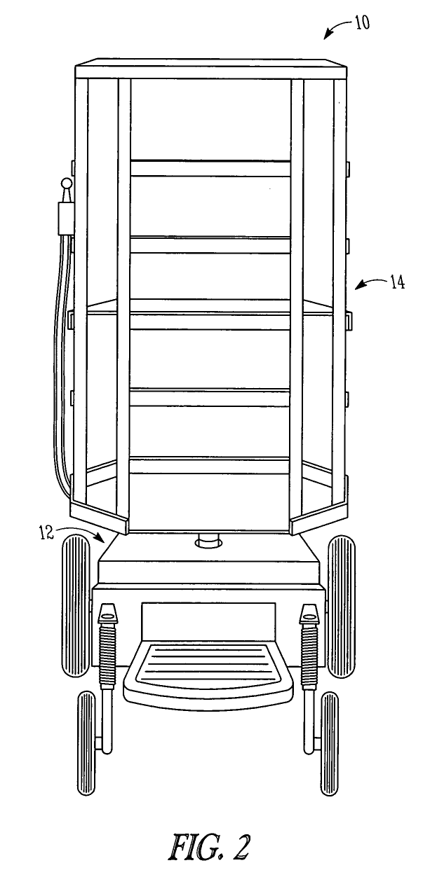

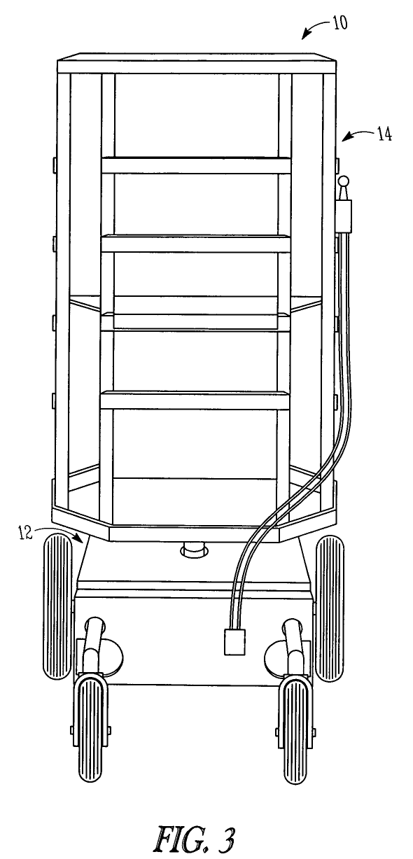

FIGS. 1-3 show one embodiment of a multi-purpose transport vehicle 10. Multi-purpose transport vehicle 10 generally includes a power unit 12 and an attachment accessory 14. The power unit 12 may have a modular configuration that permits attachment accessories having a variety of shapes and sizes depending on the intended use of the multi-purpose transport vehicle 10.

The multi-purpose transport vehicle 10 may be adapted for a variety of applications such as taping, demolition, landscaping, manufacturing, janitorial, security/police, recreation, shopping, moving medical equipment such as hospital beds, and moving agricultural products such as hay. To facilitate the use of the multi-purpose transport vehicle 10 indoors as well as outside, the multi-purpose transport vehicle 10 may be fabricated to fit through conventional doors.

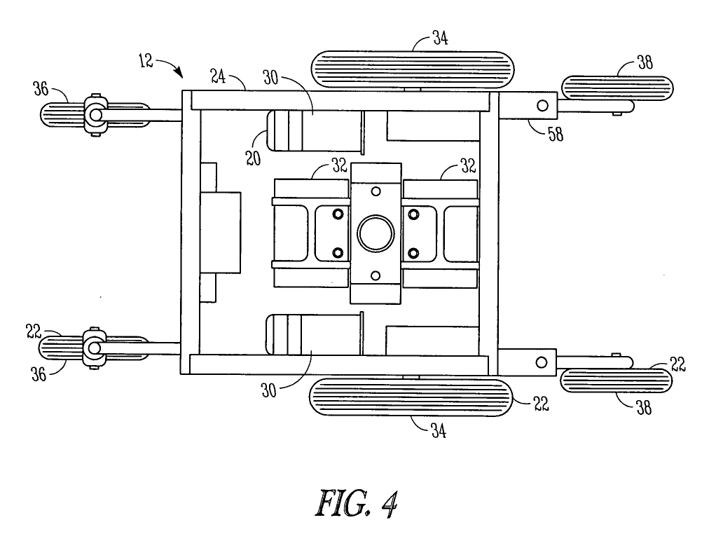

The power unit 12 generally includes a power source 20 and a plurality of wheels 22 that are both mounted with respect to a frame 24, as illustrated in FIG. 4. To enhance the potential applications in which the power unit 12 may be used, the power unit 12 may be selected with dimensions that permit the multi-purpose transport vehicle 10 to pass through conventional doorways.

The power source 20 may include at least one electric motor 30 and a battery 32 operably attached thereto. In one application, the power source 20 includes at least two electric motors 30 and at least one of the electric motors 30 is operably connected to one of the wheels 22 on each side of the power unit. To facilitate rapidly changing the battery 32, the battery 32 may be connected using a quick disconnect mechanism.

The number and size of the electric motors 30 is selected based upon the conditions under which the power source 20 will be operating. Examples of factors that affect the number and size of the electric motors 30 include the amount of weight that is placed on the power source 20 and the surface and surface orientation over which the power source 20 will be operated. A person of ordinary skill in the art will appreciate that it is possible to use alternate mechanisms for powering the power source 20 such as electric over hydraulic.

In one application, the power unit 12 includes two drive wheels 34, two front stabilizing wheels 36, and two back stabilizing wheels 38. Each of the drive wheels would be operably attached to one of the electric motors 30. Such a configuration enables the two electric motors 30 to control not only the speed of movement but also the direction of movement. By utilizing independent motors for each of drive wheels 34, vehicle 10 can make zero-radius turns. Configurations of up to six or more wheel drive, and/or tracks can be utilized with this power unit. This allows an opportunity to enlarge the base.

In one configuration, the front stabilizing wheels 36 and the back stabilizing wheels 38 are each mounted on casters that permit the front stabilizing wheels 36 and the back stabilizing wheels 38 to rotate about a vertical axis. Using this configuration enhances the ability to make sharp, zero-radius turns with the multi-purpose transport vehicle 10.

Depending on the intended use conditions, the front stabilizing wheels 36 and the back stabilizing wheels 38 may be attached to the power unit 20 using a suspension mechanism 60 that enables one or more of the front stabilizing wheels 36 and the back stabilizing wheels 38 to be deflected from the initial configuration similar to shock absorbers on an automobile. The suspension mechanism 60 is particularly useful where the multi-purpose transport vehicle 10 is intended to be used on surfaces that are not substantially flat.

Additionally, the front stabilizing wheels 36 and/or the back stabilizing wheels 38 may be configured to pivot and/or slide outwardly from the power unit 20 resulting in a wider wheel spacing than that of drive wheels 34. Pivoting and/or sliding of the front stabilizing wheels 36 and/or back stabilizing wheels 38 may be manual or mechanically assisted.

In this configuration, most of the weight of the multi-purpose transport vehicle 10 is supported by drive wheels 34. Since the front stabilizing wheels 36 and the back stabilizing wheels 38 do not need to support the weight of the multi-purpose transport vehicle 10, it is possible for the front stabilizing wheels 36 and the back stabilizing wheels 38 to have a diameter and width that is significantly smaller than the drive wheels 34.

The drive wheels 34, the front stabilizing wheels 36 and the back stabilizing wheels 38 may be fabricated from a variety of materials and sizes depending on the anticipated surfaces on which the multi-purpose transport vehicle 10 will be used as well as the weight of objects that are to be placed on the multi-purpose transport vehicle 10. Examples of possible configuration for the drive wheels 34, the front stabilizing wheels 36 and the back stabilizing wheels 38 include solid rubber, air-filled or foam-filled.

The frame 24 may be fabricated from a metallic material to provide the power unit 20 with sufficient strength to support the weight of not only the multi-purpose transport vehicle 10 but also loads or people on the multi-purpose transport vehicle 10, as illustrated in FIG. 5. In one application, the frame 24 is generally rectangular with a width of about 28 inches and a length of about 36 inches. In some embodiments, the frame 24 can have a width of about 28 inches or less and a length of about 36 inches or less. Some embodiments use a frame of more than 36 inches in length.

The frame 24 may generally be formed from a bottom portion 50 and a top portion 52. To protect the components placed in the power unit 20, the bottom portion 50 and the top portion 52 substantially encloses the components placed therein. Depending on the use conditions, the frame may also include a lock to restrict access to the components in the power unit 20.

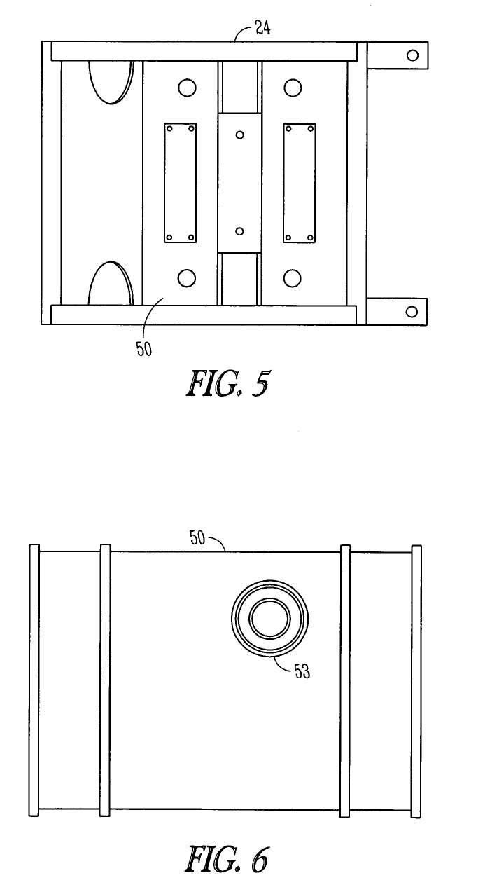

Depending on the weight that is intended to be placed on the power unit 12, all of the weight may be transferred to be wheels 22 through the electric motor 30. While this configuration works satisfactorily for relatively lower weights, damage to the electric motor 30 may result when relatively large weights are placed on the power unit 12. In these situations, a bearing 53 may be attached to the frame 24 where the axle extends through the frame 24, as illustrated in FIG. 6. The bearing 53 thereby transfer weight from the frame 24 to the wheels 22. It is also possible to use alternative suspension systems such as shock absorbers, struts or springs.

It is possible to use suspension for the drive wheels 34 that eliminates the need for suspension on the stabilizers. Such a configuration would result in less motion of the machine when going over something; with the drive wheels fixed, the whole machine will rise—or drop—the height of the obstacle/dip. With the stabilizers fixed, the machine will only rise/fall about half of that, maybe less, since the stabilizers will be doing the lift/drop, and they are located far from the center.

To facilitate attachment of the attachment accessory 14 to the power unit 12, the frame 24 includes an attachment mechanism 54, as illustrated in FIG. 1. The attachment mechanism 54 not only provides a stable attachment between the power unit 12 and the attachment accessory 14 but the attachment mechanism 54 also permits the attachment accessory 14 to be readily attached to and detached from the power unit 12.

In one configuration, the attachment mechanism 54 comprises a post 56 that extends from a central region of the frame 24 to engage a corresponding post extending from the bottom of attachment accessory 14. Some configurations of the post 56 are substantially square or circular. The attachment mechanism 54 may also include a guide such as a funnel (not shown) to guide the attachment accessory in to the desired position on the post 56. The attachment mechanism 54 may also include multiple points of engagement between the power unit 12 and the accessory attachment 14 to enhance stability of the accessory attachment 14.

The attachment mechanism 54 may also include a locking mechanism 60 to retain the attachment accessory in a stationary position on the power unit 12. One such locking mechanism 60 is a pin that extends through the post 56 and a portion of the attachment accessory.

As an alternative to attaching the attachment accessory 14 to the power unit 12 using a generally vertical movement, the attachment accessory 14 may be attached to the power unit 12 using a generally horizontal movement similar to a fifth wheel that is used for connecting trailers to trucks.

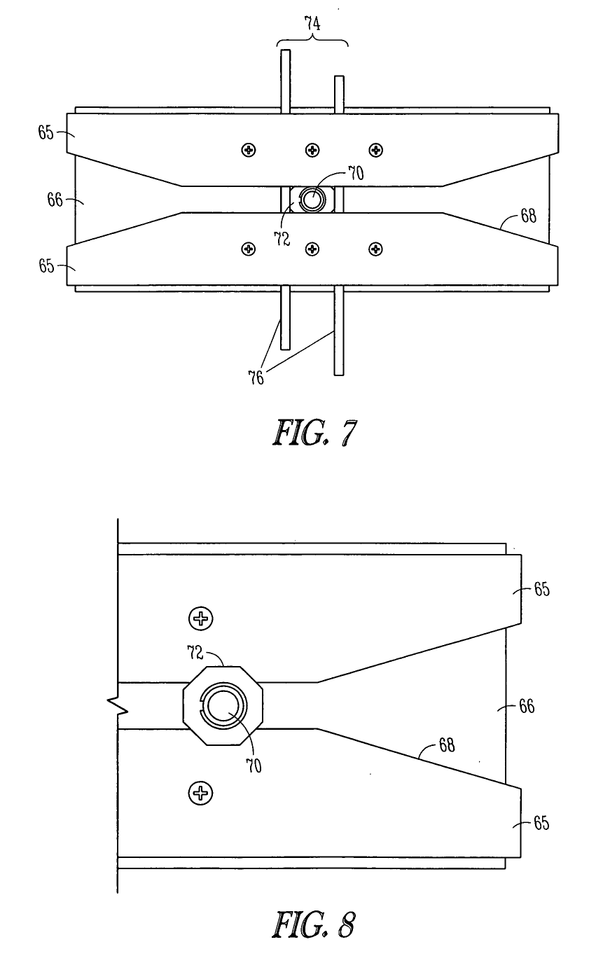

In this configuration, a pair of guide plates 65 is attached to an upper surface of the power unit 12 to provide a slot 66 therebetween, as illustrated in FIGS. 7-8. The guide plates 65 each have a channel 68 formed therein. Opposite ends of the guide plates 65 may be flared apart from each other to enhance the ability to align the attachment accessory on the power unit 12.

An elongated shaft 70 extends from a lower surface of the attachment accessory 14. The elongated shaft 70 is selected with a width that generally conforms to a distance between the guide plates 65. A plate 72 is attached to a lower end of the elongated shaft 70. The plate 72 has a width that is greater than a width of the elongated shaft 70 and that is wider than a distance between the guide plates 65.

A lock mechanism 74 is mounted with respect to the guide plates 65 to maintain the elongated shaft 70 in a desired position with respect to the guide plates 65. In one configuration that permits attachment of the attachment accessory 14 from both sides of the guide plates 65, the lock mechanism 74 includes two shafts 76 that are generally oriented substantially transverse to the guide plates 65. The shafts 76 are slidably mounted to the guide plates 65. Removing the shafts 76 from the guide plates 65 enables the attachment accessory 14 to be attached to the power unit 12.

Operation of the power unit 12 is controlled by a controller 72 such as a joystick. The joystick is a preferred mechanism for controlling the operation of the power unit 12 because a single controller enables speed and direction to be controlled. The controller 72 may either be physically connected to the power source 20 or the controller 72 may be operably connected to the power source 20 using a wireless communication circuit.

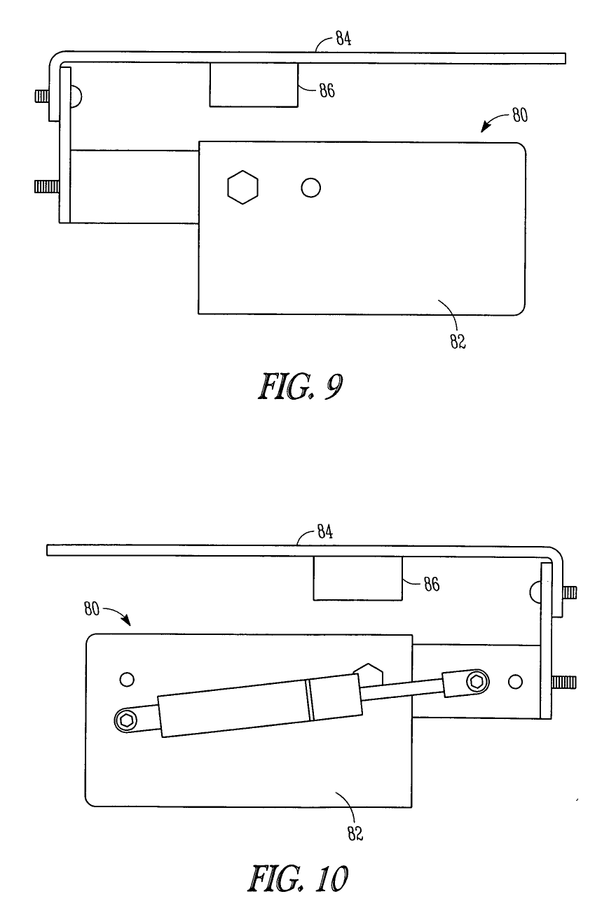

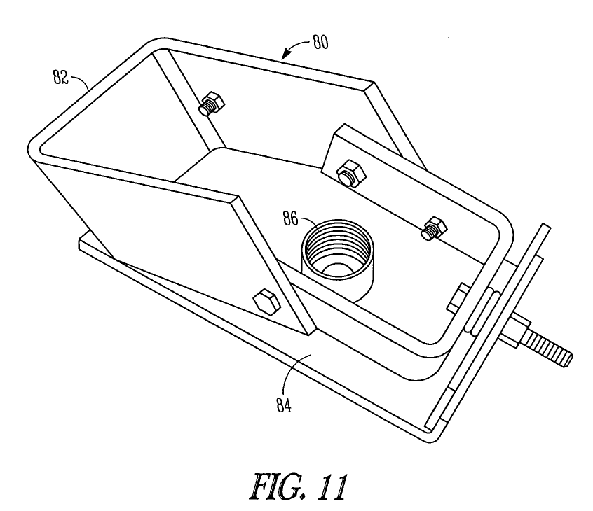

In one configuration, the controller 72 is designed to be operated with a person's hand. In another configuration, the controller 72 may be operated by the person's foot, knee or leg. It is also possible to control the operation of the power unit 12 using verbal commands. One potential controller adapter 80 for use with the controller 72 that enables the person to control the multi-purpose transport vehicle 10 with his or her foot is illustrated in FIGS. 9-11.

This controller adapter 80 includes a frame 82 that generally encloses the controller 72. The frame 82 also protects the controller 72 from damage. The adapter 80 also includes a pedal 84 that is mounted for pivoting front to back and side to side. The pedal 84 includes a receptacle 86 on a lower surface thereof in which the joystick is placed. The controller adapter 80 may include cylinders or springs that bias the pedal 84 to a neutral position.

The multi-purpose transport vehicle 10 may also include at least one sensor 42 that prevents the power unit 12 from hitting walls or other objects. For example, vehicle 10 can include a sensor 42 at each corner of power unit 12 and one or more sensors under the unit. Such sensors may utilize sonar or mechanical detection. It is also possible to use these techniques to monitor the surface over which the multi-purpose transport vehicle 10 is moving such that it does not fall off a curb or down stairs. For example, the sensors 42 can be coupled to an internal computer and to controller 72 to shut off the vehicle if the vehicle gets to close to a wall or a stairway. The sensors could be turned off to enable the multi-purpose transport vehicle to move through tight areas such as doorways.

To facilitate a person stepping on to the top of the power unit 12 or the attachment accessory 14, a step 98 may be attached to the power unit 12. The step 98 may be pivotally attached to the power unit 12 so that the step 98 may be folded to a stored position when not needed. In one configuration, the step 98 is attached to a front of the power unit 98, as illustrated in the figures.

One configuration of the attachment accessory 14 is a platform 100, as illustrated in FIG. 1. The platform 100 generally includes a base 102 and an enclosure 104. The base 102 may have a variety of shapes depending on the intended use such as square, rectangular or circular. Similarly, the base 102 is selected with a size depending on the intended use. When selecting the shape and size of the base 102 care should be exercised to provide the multi-purpose transport vehicle with sufficient stability of the intended use.

In one configuration, the platform 100 has a stationary height. In another configuration, the height of the platform 100 may be mechanically adjusted such as by using a hydraulic lift. In still another configuration, the enclosure 104 may include at least one row of rails 106 on which a step 108 may be placed.

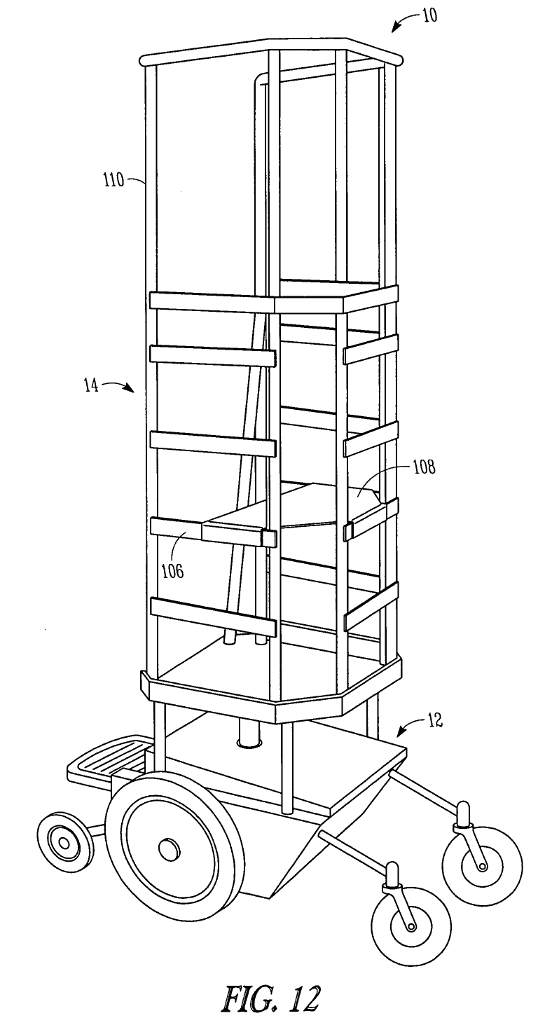

When the enclosure 104 includes at least one row of rails 106 on which the step 108 may be placed, the enclosure 104 may include a height adjustment mechanism 110 ensure that an appropriate portion of the person using the enclosure 104 is protected from falling outside of the enclosure 104, as illustrated in FIG. 12.

In one configuration, the height adjustment mechanism 110 has a telescoping configuration that permits a top rail of the enclosure 104 to be moved between a lowered configuration and at least one raised configuration. Other embodiments utilize a variety of mechanisms to maintain the height adjustment mechanism 110 in a desired height. One such mechanism is a pin that extends through at least a portion of the enclosure 104.

It is also possible to adapt accessories for use with the enclosure 104 such that they would hang on thereto. Examples of such accessories include buckets, tool holders and wire spool holders.

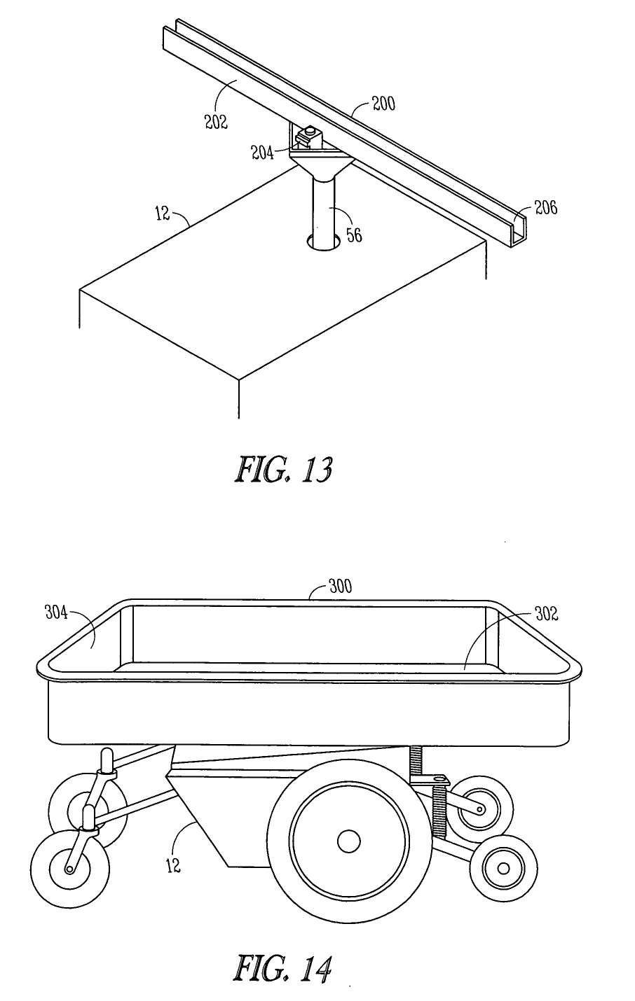

In another configuration of the multi-purpose transport system 10, an attachment accessory 200 is adapted for use in conjunction with moving a wheeled scaffold (not shown), as illustrated in FIG. 13. The attachment accessory 200 includes an elongated bar 202 with a post 204 extending therefrom. The post 204 facilitates attaching the attachment accessory 200 to the attachment post 56 of power unit 12.

The elongated bar 202 has a recess 206 extending at least partially therethrough. The recess 206 is adapted to receive a rail on the wheeled scaffold. Once the rail is placed in the recess 206, the controller may be used to move the multi-purpose transport system 10 with the wheeled scaffold attached thereto.

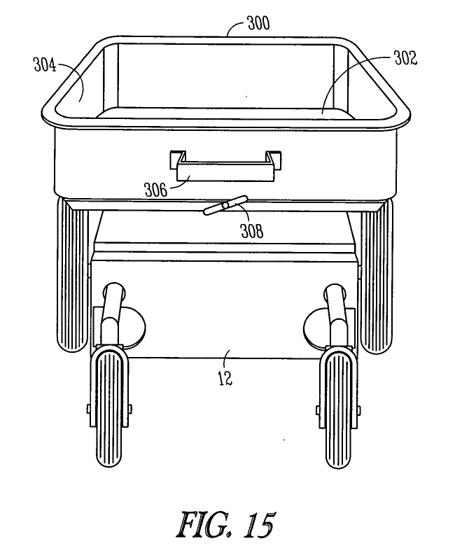

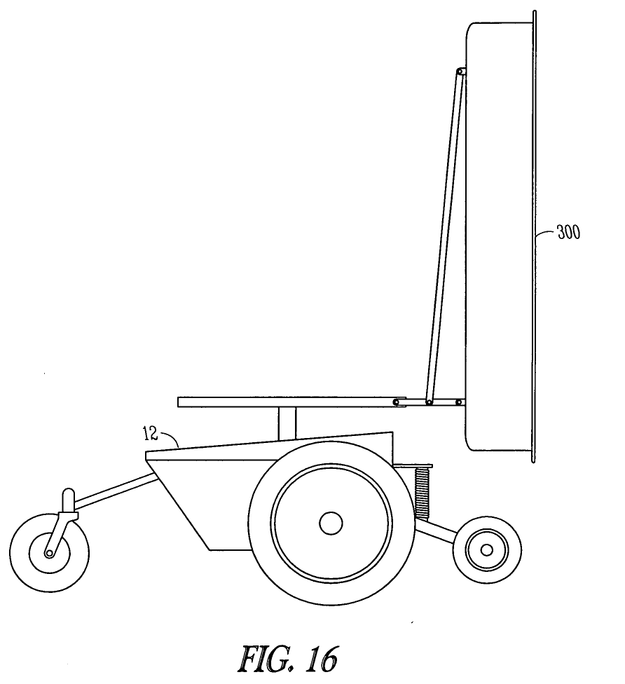

In another configuration of the multi-purpose transport system 10, an attachment accessory 300 includes a base 302 having a post (not shown) extending therefrom, as illustrated in FIGS. 14-16. The post facilitates attaching the attachment accessory 300 to the attachment post 56 of power unit 12.

The base 302 may be a substantially flat surface. As an alternative to fixedly mounting the base 302 to the power unit 12, the base 302 may be pivotally mounted to the power unit 12 to provide a dumping motion. The base 302 may also be rotatably mounted to the power unit 12. The base 302 may also include sides 304 extending therefrom. The sides 304 may be fixedly or removably mounted to the base 302. One or more of the sides 304 may be pivotally mounted to the base 302.

Pivoting the base 302 may be manually operated. Alternatively, pivoting of the base 302 may be mechanically assisted such as with a hydraulic or pneumatic cylinder. A handle 306 may be attached to the base 302 to facilitate pivoting the base 302. A lock 308 may be provided to maintain the base 302 in the horizontal position.

It is possible to utilize other objects in conjunction with the multi-purpose transport vehicle 10. Examples of such objects include running lights, work lights, safety lights, horns, and radios. It is also possible to utilize ramps for loading and unloading the multi-purpose transport vehicle 10. The ramps may be attached to the other portions of the multi-purpose transport vehicle 10 when not in use.

The above description is intended to be illustrative, and not restrictive. Many other embodiments will be apparent to those of skill in the art upon reviewing the above description. The scope of the invention should, therefore, be determined with reference to the appended claims, along with the full scope of equivalents to which such claims are entitled.

What is claimed is:

1. A transport vehicle comprising:
a power unit including a plurality of wheels;
an attachment accessory; and
an attachment mechanism configured to removably attach the attachment accessory to the power unit.

2. The transport vehicle of claim 1, wherein the power unit includes a frame, a power supply, and the plurality of wheels coupled to the frame, with the power supply operatively coupled to at least two of the wheels.

3. The transport vehicle of claim 2, wherein the power supply includes two motors, with each motor operatively coupled to one wheels such that the vehicle can perform zero-radius turns.

4. The transport vehicle of claim 1, wherein the power unit has a width of approximately 28 inches or less.

5. The transport vehicle of claim 1, wherein the attachment accessory includes a platform and an enclosure for supporting a person at an elevated height.

6. The transport vehicle of claim 5, wherein the enclosure includes a height adjustment mechanism that permits a top rail of the enclosure to be moved between a lowered configuration and at least one raised configuration.

7. The transport vehicle of claim 1, wherein the attachment accessory includes a dump box that is pivotally mounted to the power unit.

8. The transport vehicle of claim 1, wherein the attachment mechanism includes a post that extends from a central region of the frame.

9. The transport vehicle of claim 8, wherein the attachment mechanism further includes a locking mechanism to retain the attachment accessory in a stationary position on the power unit.

10. The transport vehicle of claim 1, wherein the attachment mechanism includes a pair of guide plates attached to an upper surface of the power unit to provide a slot therebetween, and an elongated shaft that extends from a lower surface of the attachment accessory, wherein the elongated shaft has a width that generally conforms to a distance between the pair of guide plates.

11. The transport vehicle of claim 10, wherein the attachment mechanism further includes a plate attached to a lower end of the elongated shaft, the plate having a width that is greater than a width of the elongated shaft and that is wider than a distance between the guide plates.

12. The transport vehicle of claim 10, wherein each of the guide plates has a channel formed therein.

13. The transport vehicle of claim 10, further comprising a lock mechanism mounted with respect to the guide plates to maintain the elongated shaft in a desired position with respect to the guide plates.

14. A transport vehicle comprising:
a frame;
a power supply;
at least six wheels coupled to the frame, with a front pair of wheels, a middle pair of drive wheels, and a rear pair of wheels, with the power supply operatively coupled to the middle pair of drive wheels, wherein the power supply includes two motors and each motor is operatively coupled to one of the drive wheels such that the vehicle can perform zero-radius turns;
an attachment accessory; and
an attachment mechanism configured to removably attach the attachment accessory to the power unit.

15. The transport vehicle of claim 14, wherein the attachment accessory includes a platform and an enclosure for supporting a person at an elevated height.

16. The transport vehicle of claim 14, wherein the attachment accessory includes a dump box that is pivotally mounted to the power unit.

17. The transport vehicle of claim 14, wherein the attachment mechanism includes a post that extends from a central region of the frame.

18. The transport vehicle of claim 14, wherein the attachment mechanism includes a pair of guide plates attached to an upper surface of the power unit to provide a slot therebetween, and an elongated shaft that extends from a lower surface of the attachment accessory, wherein the elongated shaft has a width that generally conforms to a distance between the pair of guide plates.

19. The transport vehicle of claim 18, wherein the attachment mechanism further includes a plate attached to a lower end of the elongated shaft, the plate having a width that is greater than a width of the elongated shaft and that is wider than a distance between the guide plates.

20. A method comprising:
providing a power unit including a plurality of wheels;
selectively choosing one of a plurality of attachment accessories; and
removably attaching the chosen attachment accessory to the power unit.
